(19) United States
(12) Patent Application Publication
(10) Pub. No.: US 2008/0274723 A1
(43) Pub. Date: Nov. 6, 2008

(54) Cell phone remote configuration and nap time

(75) Inventors: Joseph A. Hook, Baden, PA (US); Justin Connors, Cecil, PA (US)

Correspondence Address: Ansel M. Schwartz, Suite 304, 201 N. Craig Street, Pittsburgh, PA, 15213, US

(73) Assignee: Ericsson, Inc., Warrendale, PA (US)

(21) Appl. No.: 12/082,551

(22) Filed: Apr. 11, 2008

Related U.S. Application Data
(60) Provisional application No. 60/927,335, filed on May 3, 2007.

(51) Int. Cl. H04M 3/00; H04M 1/00

(52) U.S. Cl. 455/419; 455/567

(57) ABSTRACT

A system for using a cell phone by a user includes a cell phone. The system includes a global network in communication with the cell phone. The system includes a configuration gateway in connection with the network which remotely configures the cell phone. The system includes a remote interface not physically connected to the cell phone in communication with the configuration gateway through the network and with which a configuration choice for the cell phone is entered by the user. A cell phone includes a housing having a speaker which plays an audible tone when the phone receives a call. The housing has a vibration motor which vibrates the housing when the phone receives a call, a memory having the tone. The housing has a CPU connected with the memory and the vibration motor which configures whether the phone will vibrate or play the tone when a call is received from a remote instruction received from a configuration gateway part of a global wireless network. A method for using a cell phone by a user includes the steps of entering by the user through a remote interface not physically connected to the cell phone a configuration choice for the cell phone. There is the step of configuring remotely the cell phone with a configuration gateway in communication with a global network in communication with the cell phone and the remote interface. A method and a cell phone having a nap time. The present invention is related to a cell phone that has a nap time during which the phone is in the vibration mode that is chosen by a user.

### FIELD OF THE INVENTION

The present invention is related to changing the configuration of a cell phone without physical access to the cell phone. More specifically, the present invention is related to changing the configuration of a cell phone without physical access to the cell phone with a configuration gateway.

The present invention is related to a cell phone that has a nap time during which the phone is in the vibration mode that is chosen by a user. More specifically, the present invention is related to a cell phone that has a nap time during which the phone is in the vibration mode that is chosen by a user and a timer which determines when the nap time has passed and the phone is to return to the original operation setting.

### BACKGROUND OF THE INVENTION

Cell phones use audible tones or vibration to alert users of incoming calls or messages. Switching between these modes is normally done via a menu interface and buttons on the phone. Cell phones also have a somewhat built-in location mechanism—a misplaced phone can often be located by calling it and listening for the ring. Some cell phones/service providers currently offer mechanisms to update the phone state without keypad intervention, such as over-the-air programming, roaming database updates, voice mail indicator activation/deactivation, and transferring phone numbers from/to phones via a web interface.

The existing solution falls short in one important area. It does not support changing cell phone configuration without using the cell phone itself. If a cell phone is set to silent, vibrate-only, or even low volume, the location mechanism may not work. To locate a lost phone, it might be desired to change the mode of the phone to maximum volume to aid in locating it, a function not currently offered. The current list of changes that can be made to phone state over-the-air does not include the ringer setting or some other configuration that might be useful, particularly in the case of a lost phone.

In addition, cell phones (and other portable electronics) have become integral devices in today's work force and society. These devices may use audible signals to alert the user to some event such as an incoming phone call, email, or text message, a calendar reminder, or the loss/acquisition of a wireless network. These devices may also have a ‘silent’ mode where no audible signal is used, but silent vibration may be used. Switching between these modes is either a manual operation, or timer-based (such as automatically switching to silent mode between 10 PM and 6 AM).

The problem with the existing solution is that it does not address occasions when users wish to silence their devices for a specific time. For example, meetings, movies, and meals are examples of times when users may not wish to be disturbed or disturb those around them with noise. While some of these events may be uniform enough to program a timer-based silent period, not all events fit the regular schedule of a timer program. A user can manually silence the phone or PDA, but then the user must remember to manually return the phone to the normal mode.

### BRIEF SUMMARY OF THE INVENTION

The present invention pertains to a system for using a cell phone by a user. The system comprises a cell phone. The system comprises a global network in communication with the cell phone. The system comprises a configuration gateway in connection with the network which remotely configures the cell phone. The system comprises a remote interface not physically connected to the cell phone in communication with the configuration gateway through the network and with which a configuration choice for the cell phone is entered by the user.

The present invention pertains to a cell phone. The phone comprises a housing having a speaker which plays an audible tone when the phone receives a call. The housing has a vibration motor which vibrates the housing when the phone receives a call, a memory having the tone. The housing has a CPU connected with the memory and the vibration motor which configures whether the phone will vibrate or play the tone when a call is received from a remote instruction received from a configuration gateway part of a global wireless network.

The present invention pertains to a method for using a cell phone by a user. The method comprises the steps of entering by the user through a remote interface not physically connected to the cell phone a configuration choice for the cell phone. There is the step of configuring remotely the cell phone with a configuration gateway in communication with a global network in communication with the cell phone and the remote interface.

The present invention calls for the ability to change a cell phone configuration without physical access to the phone. The cell network could be used to command the phone and update the desired configuration by sending control channel commands, sending an SMS message containing command data for the phone, or some other communication protocol. The example highlights changing the ring setting/volume, but the invention is not limited to that application.

The present invention enhances portable electronic devices to allow the user to quickly silence them and provide a duration after which the device will automatically ‘wake up’ from its nap and return to normal operation.

The present invention pertains to a cell phone having a vibration mode where the phone responds to a call by vibrating and an audio mode where the phone responds to a call by producing a tone. The phone comprises a speaker that plays the tone. The phone comprises a vibration motor to vibrate the phone. The phone comprises an interface through which a user specifies a nap time during which the phone is in the vibration mode. The phone comprises a memory which records an original operation setting of the phone prior to entering the nap time. The phone comprises a timer which determines when the nap time has passed and the phone is to return to the original operation setting. The phone comprises a CPU that controls the phone, the CPU connected to the speaker, the vibration motor, the interface, the memory and the timer.

The present invention pertains to a method for using a cell phone having a vibration mode where the phone responds to a call by vibrating and an audio mode where the phone responds to a call by producing a tone. The method comprises the steps of specifying through an interface of the phone a nap time during which the phone is in the vibration mode. There is the step of recording in a memory of the phone an original operation setting of the phone, which is the audio mode, prior to entering the nap time. There is the step of entering the nap time with a CPU of the phone when the nap time arrives. There is the step of determining with a timer of the phone when the nap time has passed and the phone is to return to the original operation setting. There is the step of returning the phone with the CPU to the original operation setting.

### BRIEF DESCRIPTION OF THE SEVERAL VIEWS OF THE DRAWING

In the accompanying drawings, the preferred embodiment of the invention and preferred methods of practicing the invention are illustrated in which:

FIG. 1 is a block diagram of a system of the present invention.

FIG. 2 is a block diagram of a system of a cell phone with a timer.

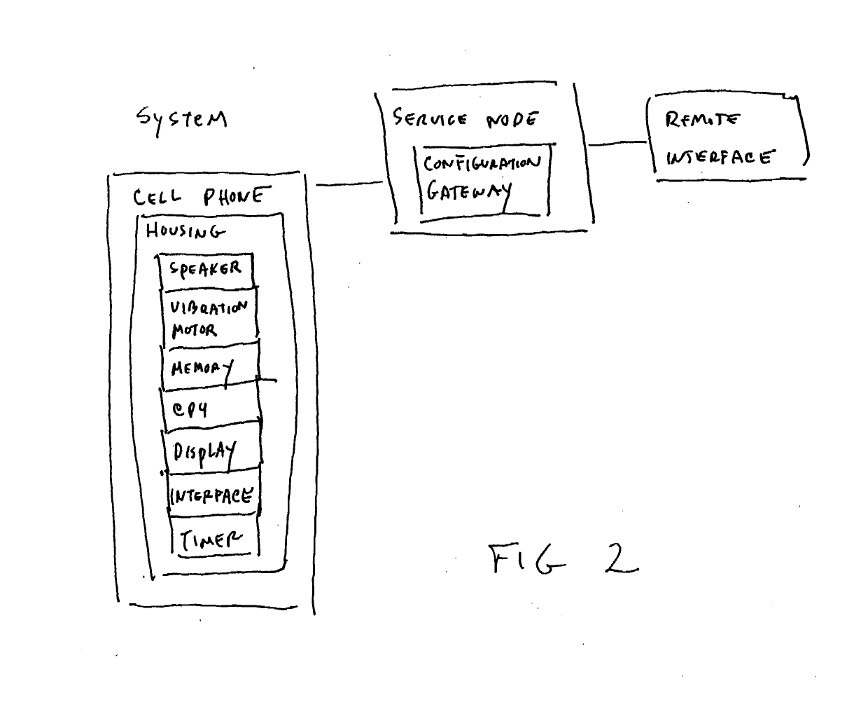

### DETAILED DESCRIPTION OF THE INVENTION

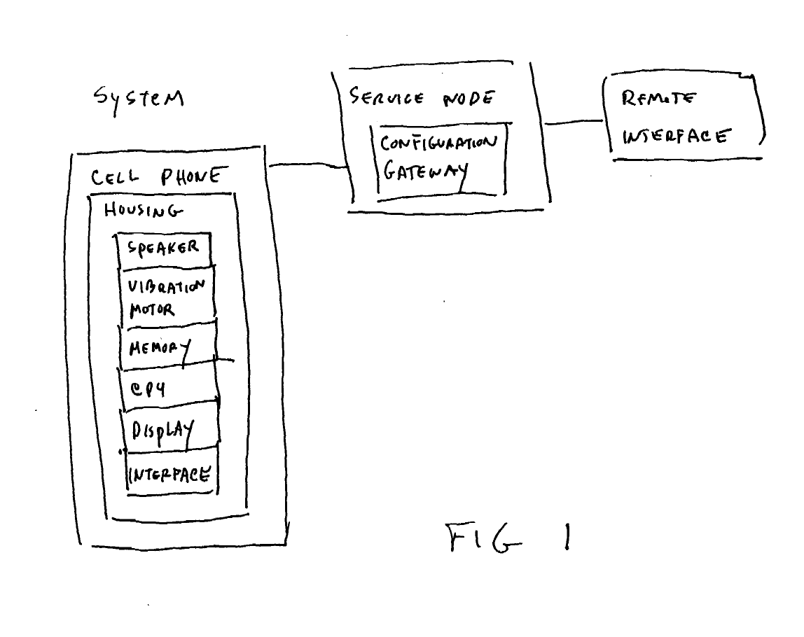

Referring now to the drawings wherein like reference numerals refer to similar or identical parts throughout the several views, and more specifically to FIG. 1 thereof, there is shown a system 10 for using a cell phone 12 by a user. The system 10 comprises a cell phone 12. The system 10 comprises a global network 14 in communication with the cell phone 12. The system 10 comprises a configuration gateway 16 in connection with the network 14 which remotely configures the cell phone 12. The system 10 comprises a remote interface 24 not physically connected to the cell phone 12 in communication with the configuration gateway 16 through the network 14 and with which a configuration choice for the cell phone 12 is entered by the user.

The network 14 can include a service node 20 and the configuration gateway 16 is part of the service node 20. The interface 18 can include a voice mail system 10 for the cell phone 12 that accesses the phone 12 configuration. The network 14 can include an Internet and then the interface 18 includes a web page that accesses the phone 12 configuration through the Internet. The interface 18 can include a zone-based service that accesses the phone 12 configuration through a configuration gateway 16 which turns off audible alerts of the phone 12. Preferably, the phone 12 configuration has a lost state with a unique audible tone associated with the lost state that is played when prompted by the user through the interface 18.

The present invention pertains to a cell phone 12. The phone 12 comprises a housing 22 having a speaker 26 which plays an audible tone when the phone 12 receives a call. The housing 22 has a vibration motor 28 which vibrates the housing 22 when the phone 12 receives a call, a memory 30 having the tone. The housing 22 has a CPU 32 connected with the memory 30 and the vibration motor 28 which configures whether the phone 12 will vibrate or play the tone when a call is received from a remote instruction received from a configuration gateway 16 part of a global wireless network 14.

The present invention pertains to a method for using a cell phone 12 by a user. The method comprises the steps of entering by the user through a remote interface 24 not physically connected to the cell phone 12 a configuration choice for the cell phone 12. There is the step of configuring remotely the cell phone 12 with a configuration gateway 16 in communication with a global network 14 in communication with the cell phone 12 and the remote interface 24.

Preferably, the network 14 includes a service node 20 and the configuration gateway 16 is part of the service node 20. The entering step can include the step of instructing a voice mail system 10 for the cell phone 12 that accesses the phone 12 configuration of the phone 12 how the phone 12 should be configured. Alternatively, the entering step includes the step of instructing a web page that accesses the phone 12 configuration through an Internet how the phone 12 should be configured. There is preferably the step of accessing the phone 12 configuration with a zone-based service through the configuration gateway 16 which turns off audible alerts of the phone 12. The entering step includes the step of instructing the phone 12 configuration which has a lost state with a unique audible tone associated with the lost state to play the unique audible tone.

In the operation of the invention, cell phones 12 are one component of a global network 14 that includes other user interfaces such as PDAs, laptops, PCs, gaming systems, fax machines, and phones 12. The global network 14 also contains many services provided by services nodes, such as Multimedia GateWays, Video On Demand servers, IP Multimedia Subsystems, the World Wide Web, Voice Mail, and Radio Network Controllers. A network 14 of switches, routers, and aggregators allows the user interfaces 18 to communicate with each other and the network 14 services. Introducing a Configuration GateWay to the network 14 would allow users to remotely configure cell phones 12 using the global network 14. Note that the configuration gateway 16 need not be a physical device, but could be a software application residing within one or more service nodes 20.

Users would configure cell phones 12 by communicating with the configuration gateway 16 through a remote interface 24—an interface 18 not physically connected to the cell phone 12. The remote interface 24 could take many forms. An example interface 18 would be to use the voice mail system 10, which has the advantages of being accessible from any phone 12 and password protected. A new top-level entry could be added to access phone 12 configuration. Selecting that choice, through a button push, voice command, or any means normally used to navigate the voice mail system 10, would put the user in a configuration sub-menu. That menu could either have options for controlling the ringer configuration or another menu level of selecting which configuration to change.

Example Voice Mail Menu Structure:

1-Mailbox options

2-Play message

7-Delete current message

8-Access configuration
1-Ringer mode/volume
   1-Max volume, vibrate off
   2-Max volume, vibrate on

2-Ring tone
1-‘Lost phone’ tone
2-Normal

3-GPS mode
1-Enable location tracking
2-Disable location tracking

4-Call mode
1-Secure mode—calls to/from pre-selected number only
2-Normal mode

Another example interface 18 that could be used instead of or in addition to the voice mail interface 18 is a web page interface 18. This has similar advantages of being accessible from any web browser and can be password protected. A similar set of options would be provided, but the user would use the Internet and a web browser to modify settings.

Other interfaces 18 might be simpler and less interactive. One such example would be a zone-based service such as automatic silencing. When a user entered a ‘quiet’ area, such as a library or movie theater, the zone-based service would request via the configuration gateway 16 that the phone 12 turn off audible alerts. There is still a user interface 18, but the action taken by the user is simply to enter and exit the area identified by the zone-based service.

In any case, the cell phone 12 network 14 would be used to remotely connect the phone 12 to the user interface 18.

Users can change the configuration of their phone 12 without using the provided menu/button interface 18. This could aid in the location of misplaced phones or prevent misuse of a stolen phone. Other enhancements could add to the value of the invention. If an industry-standard tone was selected to indicate a lost cell phone, remotely changing to this tone could signal bystanders of a lost phone. Bystanders would be more likely to answer a phone that didn't belong to them if they knew it was lost and being called in an effort to locate it.

For cell phone 12 service providers, this feature could be a differentiator from other providers. Because the interface 18 is automated, no additional customer service would be necessary to support the feature once the initial infrastructure was in place. Customer service calls might actually be reduced because fewer customers might call to put their phone 12 on hold until it was located.

For cell phone 12 manufacturers, this feature could also be a differentiator. Users may consider whether or not this feature is available when purchasing a phone 12.

Cell phones 12 run a proprietary software layer on a microprocessor. The specifics vary from phone to phone. The cell phone 12 software is updated to communicate with the configuration gateway 16. That could either involve expanding existing protocols such as SMS or the control channel protocol to include configuration commands/messages, or adding a new protocol, defined specifically for sending configuration commands/messages. Cell phones 12 contain non-volatile memory 30 (memory that keeps its contents when the power is off) that stores the configuration information. The configuration information stored in the non-volatile memory 30 is modified by using the keypad/display 34 on the phone 12 or with instructions from the configuration gateway 16.

The configuration gateway 16 is primarily a translator between the different languages/protocols of the different systems. Internet servers communicate with web browsers with html, java, or xml over IP. Voice mail systems use their own communication protocol to relay information between the call center, the message storage mechanism, and account information server. Cell phones 12 use their own communication protocols over the radio network 14 and supporting infrastructure. The configuration gateway 16 speaks multiple protocols such that it could interpret between the internet protocol and the radio network 14 protocol and between the voice mail protocol and the radio network 14 protocol. Generally speaking, it would not be limited to these protocols, but those are the ones mentioned as examples.

An optional function of the configuration gateway 16 and added cell phone 12 software would be a layer of security. This provides a way of authenticating that configuration commands/messages were genuine and from an authorized source. The security layer could include a password.

The present invention pertains to a cell phone 12 having a vibration mode where the phone 12 responds to a call by vibrating and an audio mode where the phone 12 responds to a call by producing a tone. The phone 12 comprises a speaker 26 that plays the tone. The phone 12 comprises a vibration motor 28 to vibrate the phone 12. The phone 12 comprises an interface 18 through which a user specifies a nap time during which the phone 12 is in the vibration mode. The phone 12 comprises a memory 30 which records an original operation setting of the phone 12 prior to entering the nap time. The phone 12 comprises a timer 36 which determines when the nap time has passed and the phone 12 is to return to the original operation setting. The phone 12 comprises a CPU 32 that controls the phone 12, the CPU 32 connected to the speaker 26, the vibration motor 28, the interface 18, the memory 30 and the timer 36.

The present invention pertains to a method for using a cell phone 12 having a vibration mode where the phone 12 responds to a call by vibrating and an audio mode where the phone 12 responds to a call by producing a tone. The method comprises the steps of specifying through an interface 18 of the phone 12 a nap time during which the phone 12 is in the vibration mode. There is the step of recording in a memory 30 of the phone 12 an original operation setting of the phone 12, which is the audio mode, prior to entering the nap time. There is the step of entering the nap time with a CPU 32 of the phone 12 when the nap time arrives. There is the step of determining with a timer 36 of the phone 12 when the nap time has passed and the phone 12 is to return to the original operation setting. There is the step of returning the phone 12 with the CPU 32 to the original operation setting.

In the operation of the invention, the cell phone 12 includes a button, menu, voice-activated or other interface 18 to allow the user to invoke the new mode where the interface 18 would allow the user to specify a nap time. The devices would include a memory 30 to record the original operation setting and a timer 36 to indicate when the device should return to the original mode. The device could optionally include a means of adjusting the timer 36 while the device was napping.

Users could quickly silence portable electronic devices to avoid creating noisy distractions without having to remember to manually return the devices to normal operation.

Although the invention has been described in detail in the foregoing embodiments for the purpose of illustration, it is to be understood that such detail is solely for that purpose and that variations can be made therein by those skilled in the art without departing from the spirit and scope of the invention except as it may be described by the following claims.

1. A system for using a cell phone by a user comprising:
a cell phone;
a global network in communication with the cell phone;
a configuration gateway in connection with the network which remotely configures the cell phone;
a remote interface not physically connected to the cell phone in communication with the configuration gateway through the network and with which a configuration choice for the cell phone is entered by the user.

2. A system as described in claim 1 wherein the network includes a service node and the configuration gateway is part of the service node.

3. A system as described in claim 1 wherein the interface includes a voice mail system for the cell phone that accesses the phone configuration.

4. A system as described in claim 1 wherein the network includes an Internet.

5. A system as described in claim 4 wherein the interface includes a web page that accesses the phone configuration through the Internet.

6. A system as described in claim 1 wherein the interface includes a zone-based service that accesses the phone configuration through a configuration gateway which turns off audible alerts of the phone.

7. A system as described in claim 1 wherein the phone configuration has a lost state with a unique audible tone associated with the lost state that is played when prompted by the user through the interface.

8. A cell phone comprising:
a housing having a speaker which plays an audible tone when the phone receives a call, a vibration motor which vibrates the housing when the phone receives a call, a memory having the tone, and a CPU connected with the memory and the vibration motor which configures whether the phone will vibrate or play the tone when a call is received from a remote instruction received from a configuration gateway part of a global wireless network.

9. A method for using a cell phone by a user comprising the steps of:
entering by the user through a remote interface not physically connected to the cell phone a configuration choice for the cell phone; and
configuring remotely the cell phone with a configuration gateway in communication with a global network in communication with the cell phone and the remote interface.

10. A method as described in claim 9 wherein the network includes a service node and the configuration gateway is part of the service node.

11. A method as described in claim 9 wherein the entering step includes the step of instructing a voice mail system for the cell phone that accesses the phone configuration of the phone how the phone should be configured.

12. A method as described in claim 9 wherein the entering step includes the step of instructing a web page that accesses the phone configuration through an Internet how the phone should be configured.

13. A method as described in claim 9 including the step of accessing the phone configuration with a zone-based service through the configuration gateway which turns off audible alerts of the phone.

14. A method as described in claim 9 wherein the entering step includes the step of instructing the phone configuration which has a lost state with a unique audible tone associated with the lost state to play the unique audible tone.

15. A cell phone having a vibration mode where the phone responds to a call by vibrating and an audio mode where the phone responds to a call by producing a tone comprising:
a speaker that plays the tone;
a vibration motor to vibrate the phone;
an interface through which a user specifies a nap time during which the phone is in the vibration mode;
a memory which records an original operation setting of the phone prior to entering the nap time;
a timer which determines when the nap time has passed and the phone is to return to the original operation setting; and
a CPU that controls the phone, the CPU connected to the speaker, the vibration motor, the interface, the memory and the timer.

16. A method for using a cell phone having a vibration mode where the phone responds to a call by vibrating and an audio mode where the phone responds to a call by producing a tone comprising the steps of:
specifying through an interface of the phone a nap time during which the phone is in the vibration mode;
recording in a memory of the phone an original operation setting of the phone, which is the audio mode, prior to entering the nap time;
entering the nap time with a CPU of the phone when the nap time arrives;
determining with a timer of the phone when the nap time has passed and the phone is to return to the original operation setting; and
returning the phone with the CPU to the original operation setting.
